(19) United States
(12) Patent Application Publication
(10) Pub. No.: US 2012/0317356 A1
(43) Pub. Date: Dec. 13, 2012

(54) SYSTEMS AND METHODS FOR SHARING MEMORY BETWEEN A PLURALITY OF PROCESSORS

(75) Inventor: Michael Ignatowski, Austin, TX (US)

(73) Assignee: ADVANCED MICRO DEVICES, INC., Sunnyvale, CA (US)

(21) Appl. No.: 13/156,845

(22) Filed: Jun. 9, 2011

(51) Int. Cl. G06F 13/00

(52) U.S. Cl. 711/114; 711/154; 711/E12.001

(57) ABSTRACT

Systems and methods for sharing memory between a plurality of processors are provided. In one example, a shared memory system is disclosed. The system includes at least two processors and at least two memory devices, such as passive variable resistive memory (PVRM) devices. Each memory device is operatively connected to each processor via one of a plurality of processor interfaces. Each processor interface is dedicated to a single processor of the at least two processors. In this manner, any individual processor of the at least two processors is operative to access data stored in any individual memory device of the at least two memory devices via the processor interface dedicated to that respective individual processor.

### FIELD OF THE DISCLOSURE

The present disclosure relates to systems and methods for sharing memory between a plurality of processors.

### BACKGROUND OF THE DISCLOSURE

In traditional shared memory systems (i.e., computing systems including multiple discrete memory devices), each memory device (e.g., memory chip) or memory module (i.e., one or more memory devices mounted, for example, on a printed circuit board) only contain a single processor interface. That is, in conventional shared memory systems, each memory device/memory module is only directly connected to a single processor (e.g., a processor chip). Thus, if processors other than the processor directly connected to the memory device/memory module of interest want to access data stored in the memory device/memory module of interest, they must do so via the directly connected processor. This is problematic because the processor that is directly connected to the memory device/module storing the desired data may become defective. In prior art shared memory systems, when a processor directly connected to the memory device/memory module containing the desired data becomes defective, that desired data becomes inaccessible. Other drawbacks and problems associated with conventional shared memory systems will be recognized by those having ordinary skill in the art.

Redundant Array of Inexpensive Disks (RAID) refers to various techniques and architectures for dividing and replicating computer data storage among multiple hard disks. There are several known RAID techniques, and each respective RAID technique is described by the word “RAID” followed by a number indicating the specific level of RAID (e.g., RAID 0, RAID 1, etc.). When multiple hard disks are set up in a RAID architecture so as to implement one or more of the various RAID levels (e.g., RAID 0), the hard disks are said to be in a RAID array. Generally, RAID techniques and architectures are known to improve disk storage reliability.

For example, in RAID 1 (i.e., level one RAID) data is written identically to multiple hard disks. This is known as “mirroring,” and ensures that, in the event any individual hard disk becomes defective, the desired data may still be obtained by one of the other hard disks storing the “mirrored” data. In this manner, RAID 1 provides redundant storage of certain data (e.g., critical data) to improve storage reliability. RAID 2, on the other hand, provides bit-level striping with dedicated Hamming-code parity. That is, in RAID 2, each sequential bit in a given piece of data is “striped” (i.e., written to) a different hard disk. Hamming-code parity is calculated across corresponding bits on hard disks and stored on one or more parity disks (i.e., hard disks dedicated to storing the parity bits). In this manner, when an individual disk storing one of the striped bits becomes defective, the overall piece of data (of which the lost bit formed a part) may still be reconstructed using the bits obtained from the functioning hard disks in conjunction with the parity bits, using reconstruction techniques known in the art. Various other levels of RAID are also known that operate similarly to the RAID 1 and RAID 2 implementations discussed above with additional nuances.

However, hard disk technology appears to nearing the end of its useful life-cycle (or at least its importance appears to be waning) as new types of storage are emerging that exhibit substantially faster access times than hard disk, are smaller than hard disks, and provide the same non-volatility that hard disks provide. Accordingly, one drawback associated with prior art RAID systems is that hard disks continue to be used as the persistent storage mechanisms.

Accordingly, a need exists for systems and methods for sharing memory between a plurality of processors, particularly in a RAID memory architecture.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting one example of a shared memory system for sharing memory between a plurality of processors.

FIG. 2 is a block diagram generally depicting one detailed example of the memory devices that may be employed in the shared memory system of FIG. 1.

FIG. 3 is a block diagram generally depicting another example of a shared memory system for sharing memory between a plurality of processors.

FIG. 4 is a block diagram generally depicting one detailed example of the memory modules that may be employed in the shared memory system of FIG. 3.

FIG. 5 is a block diagram generally depicting one example of another shared memory system for sharing memory between a plurality of processors, wherein the memory modules are external to the assembly including the processors.

FIG. 6 is a flowchart illustrating one example of a method for making a shared memory system.

FIG. 7 is a flowchart illustrating another example of a method for making a shared memory system.

FIG. 8 is a flowchart illustrating one example of a method for sharing memory between at least two processors.

### SUMMARY OF THE EMBODIMENTS

The present disclosure provides systems and methods for sharing memory between a plurality of processors. In one example, a shared memory system is disclosed. In this example, the shared memory system includes at least two processors and at least two memory devices, each memory device being operatively connected to each processor via one of a plurality of processor interfaces. Each processor interface is dedicated to a single processor of the at least two processors. In this manner, any individual processor of the at least two processors is operative to access data stored in any individual memory device of the at least two memory devices via the processor interface dedicated to a respective individual processor.

In one example, each processor is operatively connected to a dedicated power supply. As such, a failure associated with any individual processor will not prohibit another processor from accessing data stored in any of the memory devices. In another example, the at least two memory devices are passive variable resistive (PVRM) memory devices, such as phase-change memory devices, spin-torque transfer magnetoresistive memory devices, and/or memristor memory devices.

In one example, the shared memory system includes an assembly, wherein the assembly includes the at least two processors. In another example, the assembly also includes the at least two memory devices, wherein each memory device is operatively connected to each processor via a respective dedicated bus. In still another example, each memory device is external to the assembly and operatively connected to each processor via a respective dedicated bus.

In another example, each memory device includes arbitration logic and at least one memory bank. In this example, the arbitration logic is operatively connected to each at least one memory bank and each processor interface. The arbitration logic is operative to determine which individual processor of the at least two processors to provide with exclusive access to any at least one memory bank at a given time.

In one example, at least one of the at least two processors further includes RAID mode initialization logic operative to configure the at least two memory devices as a RAID memory system. In another example, at least one of the at least two memory devices is a parity memory device operative to store parity data used to reconstruct data requested from at least one memory device other than the at least one parity memory device. In yet another example, at least one of the at least two processors further includes: (1) RAID parity data generation logic operative to generate parity data for storage in the at least one parity memory device and (2) RAID data reconstruction logic operative to reconstruct requested data that was not received from a defective memory device based on the parity data.

The present disclosure also provides another example of a shared memory system. In this example, the shared memory system includes at least two processors and at least two memory modules, each memory module being operatively connected to each processor via one of a plurality of processor interfaces. Each processor interface is dedicated to a single processor of the at least two processors. In this manner, any individual processor of the at least two processors is operative to access data stored in any individual memory module of the at least two memory modules via the processor interface dedicated to a respective individual processor.

The present disclosure also provides methods for making shared memory systems. In one example of a method for making a shared memory system, at least two processors and at least two memory devices are placed on an assembly. Each memory device is operatively connected to each processor via one of a plurality of processor interfaces, wherein each processor interface is dedicated to a single processor of the at least two processors. In one example, the assembly is placed on a socket package.

In another example of a method for making a shared memory system, at least two processors and at least two memory modules are placed on an assembly. Each memory module is operatively connected to each processor via one of a plurality of processor interfaces, wherein each processor interface is dedicated to a single processor of the at least two processors. In one example, the assembly is placed on a socket package.

Finally, the present disclosure provides a method for sharing memory between at least two processors. In one example, the method includes receiving, by a memory module, a first memory request from a first processor via a dedicated first processor interface. The memory module also receives a second memory request from a second processor via a dedicated second processor interface. In this example, the method further includes determining, by the memory module, which memory request of the first and second memory requests to honor first in time.

Among other advantages, the disclosed systems and methods provide a shared memory system capable of implementing RAID without the use of hard disks. Using non-hard disk types of storage (e.g., PVRM) reduces memory access time, minimizes the size of the memory system, and, in one embodiment, provides persistent (i.e., non-volatile) storage. Additionally, the disclosed systems and methods provide memory devices and memory modules having dedicated processor interfaces for a plurality of processors. In this manner, when any individual processor becomes defective, other functional processors may still access data stored in a given memory device/memory module. Other advantages will be recognized by those of ordinary skill in the art.

### DETAILED DESCRIPTION OF THE EMBODIMENTS

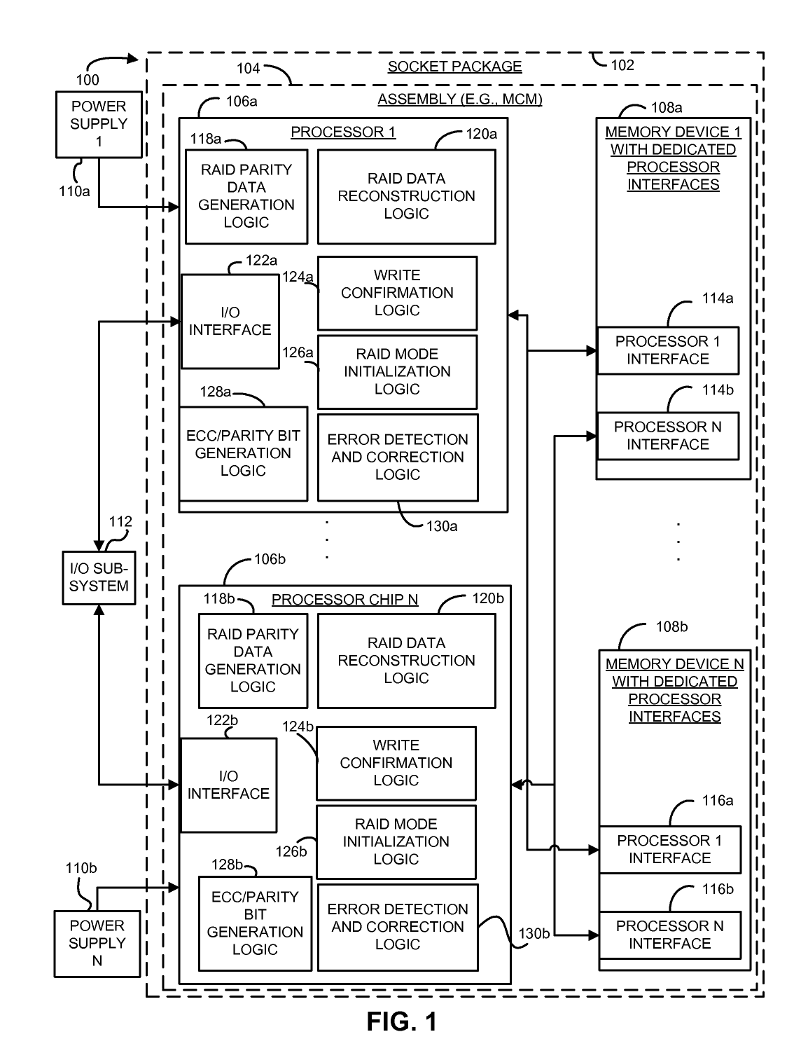

The following description of the embodiments is merely exemplary in nature and is in no way intended to limit the disclosure, its application, or uses. FIG. 1 illustrates one example of a shared memory system 100 for sharing memory (e.g., memory devices 108a, 108b) between a plurality of processors (e.g., processors 106a, 106b) in accordance with the present disclosure. The system 100 may exist, for example, in any type of computing device such as a traditional computer (e.g., a desktop or laptop computer), personal digital assistant (PDA), cellular telephone, tablet (e.g., an Apple® iPad®), one or more networked computing devices (e.g., server computers or the like, wherein each individual computing device implements one or more functions of the system 100), camera, or any other suitable electronic device. The system 100 includes a plurality of processors, such as processor 1 106a and processor N 106b. While only two processors are depicted, it is appreciated that the system 100 may include as many processors (e.g., “N” processors) as required. Any of the processors (e.g., processor 1 106a and processor N 106b) may comprise one or more microprocessors, microcontrollers, digital signal processors, or combinations thereof operating under the control of executable instructions stored in the storage components. Furthermore, any of the processors may include one or more cores.

The system further includes a plurality of memory devices with dedicated processor interfaces, such as memory device 1 108a and memory device N 108b. While only two memory devices are depicted, it is appreciated that the system 100 may include as many memory devices as desired. Any of the memory device (e.g., memory device 1 108a and memory device N 108b) may comprise any suitable type of volatile or non-volatile memory, with the exception of hard disk. For example, the memory devices 108a, 108b may comprise passive variable resistive memory (PVRM), Flash memory, or any other persistent or volatile memory known in the art.

PVRM is a broad term used to describe any memory technology that stores state in the form of resistance instead of charge. That is, PVRM technologies use the resistance of a cell to store the state of a bit, in contrast to charge-based memory technologies that use electric charge to store the state of a bit. PVRM is referred to as being passive due to the fact that it does not require any active semiconductor devices, such as transistors, to act as switches. These types of memory are said to be “non-volatile” due to the fact that they retain state information following a power loss or power cycle. Passive variable resistive memory is also known as resistive non-volatile random access memory (RNVRAM or RRAM).

Examples of PVRM include, but are not limited to, Ferroelectric RAM (FeRAM), Magnetoresistive RAM (MRAM), Memristors, Phase Change Memory (PCM), and Spin-Torque Transfer MRAM (STT-MRAM). While any of these technologies may be suitable for use in conjunction with a shared memory system, such as shared memory system 100 disclosed herein, PCM, memristors, and STT-MRAM are contemplated as providing an especially nice fit and are therefore discussed below in additional detail.

Phase change memory (PCM) is a PVRM technology that relies on the properties of a phase change material, generally chalcogenides, to store state. Writes are performed by injecting current into the storage device, thermally heating the phase change material. An abrupt shutoff of current causes the material to freeze in an amorphous state, which has high resistivity, whereas a slow, gradual reduction in current results in the formation of crystals in the material. The crystalline state has lower resistance than the amorphous state; thus a value of 1 or 0 corresponds to the resistivity of a cell. Varied current reduction slopes can produce in-between states, allowing for potential multi-level cells. A PCM storage element consists of a heating resistor and chalcogenide between electrodes, while a PCM cell is comprised of the storage element and an access transistor.

Memristors are commonly referred to as the “fourth circuit element,” the other three being the resistor, the capacitor, and the inductor. A memristor is essentially a two-terminal variable resistor, with resistance dependent upon the amount of charge that passed between the terminals. Thus, a memristor's resistance varies with the amount of current going through it, and that resistance is remembered even when the current flow is stopped. One example of a memristor is disclosed in corresponding U.S. Patent Application Publication No. 2008/0090337, having a title “ELECTRICALLY ACTUATED SWITCH”, which is incorporated herein by reference.

Spin-Torque Transfer Magnetoresistive RAM (STT-MRAM) is a second-generation version of MRAM, the original of which was deemed “prototypical” by the International Technology Roadmap for Semiconductors (ITRS). MRAM stores information in the form of a magnetic tunnel junction (MTJ), which separates two ferromagnetic materials with a layer of thin insulating material. The storage value changes when one layer switches to align with or oppose the direction of its counterpart layer, which then affects the junction's resistance. Original MRAM required an adequate magnetic field in order to induce this change. This was both difficult and inefficient, resulting in impractically high write energy. STT-MRAM uses spin-polarized current to reverse polarity without needing an external magnetic field. Thus, the STT technique reduces write energy as well as eliminating the difficult aspect of producing reliable and adequately strengthened magnetic fields. However, STT-MRAM, like PCM, requires an access transistor and thus its cell size scaling depends on transistor scaling.

In any event, each processor 106a, 106b is operatively connected to each memory device 108a, 108b over a suitable communication channel or channels, such as one or more buses, via a dedicated processor interface (e.g., processor interfaces 114a, 114b, 116a, 116b). That is, each memory device includes a dedicated processor interface for each processor in the system 100. Further, the address space of all of the memory devices is accessible by all of the processors. In this manner, if any individual processor (e.g., processor 1 106a) becomes defective (e.g., because of a mechanical or power failure), any other functioning processor (e.g., processor N 106b) may still access the data stored in any of the memory devices (e.g., memory device 1 108a and/or memory device N 108b). In prior art systems, each memory device would only be directly connected to a single processor. Thus, if a processor became defective, it would not be possible to access the data stored in the memory device directly connected to the defective processor. Accordingly, the shared memory system 100 of the present disclosure provides a more robust architecture as compared to conventional memory systems, whereby the failure of any given processor will not inhibit access to data stored on a memory device directly connected to the defective processor.

Additionally, each processor is implemented with a suitable isolation mechanism such as a dedicated power supply (e.g., power supply 1 110a and power supply N 110b), such that the failure of any component in the system 100, or the failure of power being delivered to any component in the system 100, is unlikely to effect the continued operation of the other components in the system 100. That is to say, a power failure associated with any individual processor (e.g., processor 106a) will not prohibit another processor (e.g., processor 106b) from accessing data stored in any of the memory devices (e.g., memory devices 108a, 108b).

The power supplies 110a, 110b are operatively connected to the processors 106a, 106b via one or more suitable power supply channels, as known in the art. In one example, the processors 106a, 106b and the memory devices 108a, 108b are arranged on the same assembly 104, such as a multi-chip module (MCM). In one example, the assembly 104 itself is arranged on a socket package 102. As known in the art, a socket package, such as socket package 102, is a mechanical component that provides mechanical and electrical connections between one or more devices (e.g., processors 106a, 106b) and a printed circuit board (not shown).

Each of the processors 106a, 106b may include an I/O interface 122a, 122b, RAID parity generation logic 118a, 118b, RAID data reconstruction logic 120a, 120b, write confirmation logic 124a, 124b, RAID mode initialization logic 126a, error correcting code (ECC)/parity bit generation logic 128a, 128b, and error detection and correction logic 130a, 130b. The I/O interfaces 122a, 122b are used for communication with an I/O subsystem, which may include, for example, input devices (e.g., mouse, keyboard, etc.), output devices (e.g., printer, speaker, etc.), additional processors, memory, or any other suitable I/O component known in the art. Each I/O interface includes logic necessary to communicate with any of the components of the I/O subsystem 112.

The ECC/parity bit generation logic 128a, 128b includes logic (i.e., hardware and/or stored software capable of execution by any of the processors) operative to generate ECC/parity bit data that may be transmitted by the processors to any of the memory devices along with a store operation over the communication channel(s) between the processors and the memory devices. The error detection and correction logic 130a, 130b includes logic (i.e., hardware and/or stored software capable of execution by any of the processors) operative to evaluate any data returned to a processor upon a fetch operation, in conjunction with the returned ECC/parity bit data, in order to determine whether the returned data is accurate. For example, the error detection and correction logic 130a, 130b is operative to detect “soft” errors in the returned data (i.e., small-scale errors where the returned data is only inaccurate by a few bits/bytes). Upon detection of such soft errors, the error detection and correction logic 130a, 130b is further operative to correct the errors based on the ECC/parity bit data using data correction techniques known in the art. In this manner, the ECC/parity bit generation logic 128a, 128b and the error detection and correction logic 130a, 130b may be employed to further improve the reliability of the shared memory system 100.

The RAID mode initialization logic 126a, 126b includes logic (i.e., hardware and/or stored software capable of execution by any of the processors) operative to set up the shared memory system 100 as a particular RAID level. For example, the RAID mode initialization logic 126a, 126b may configure the system 100 to perform all stores in accordance with RAID 1 operating procedure. In such a case, any data stored to any individual memory device (e.g., memory device 1 108a) will also be stored in duplicate to another memory device (e.g., memory device N 108b) to provide the “mirroring” effect associated with RAID 1. In this manner, the RAID mode initialization logic 126a, 126b is operative to configure the at least two memory devices 108a, 108b as a RAID memory system.

When the RAID mode initialization logic 126a, 126b has initialized the shared memory system 100 to operate with a RAID level that utilizes parity bit generation (e.g., RAID 2), the RAID parity data generation logic 118a, 118b and the RAID data reconstruction logic 102a, 120b may be employed. The RAID parity data generation logic 118a, 118b is operative to generate RAID parity data that may be transmitted by any of the processors to a memory device (e.g., memory device 108a) that serves as a parity memory device when the shared memory system 100 is configured in a RAID level utilizing parity bit generation. Stated another way, when the shared memory system 100 is configured to operate at a RAID level that uses RAID parity data, at least one of the memory devices will serve as a parity memory device operative to store the RAID parity data. The RAID parity data may be used to reconstruct data requested from a memory device other than the parity memory device, as will be discussed with respect to the RAID data reconstruction logic 120a, 120b below. In one example, the RAID parity data generation logic 118a, 118b includes logic (i.e., hardware and/or stored software capable of execution by any of the processors) operative to generate parity data for storage in the at least one parity memory device.

The RAID data reconstruction logic 120a, 120b includes logic (i.e., hardware and/or stored software capable of execution by any of the processors) operative to reconstruct requested data that was not received from a defective memory device, based on the RAID parity data. For example, in certain circumstances one of the memory devices (e.g., memory device 108a) may become defective (e.g., from a mechanical failure). Furthermore, assuming that the shared memory system 100 is operating in a RAID level utilizing data striping, a sub component of a complete piece of data (e.g., a bit or byte of the complete piece of data) may have been stored on the defective memory device. Accordingly, when one of the processors attempts to fetch the complete piece of data, the sub component of that complete piece of data that was stored on the defective memory device may not be returned. Nonetheless, the RAID data reconstruction logic 120a, 120b may reconstruct the complete piece of data based upon the sub components of data that were returned (i.e., the sub components of the data from the functioning memory devices) and the RAID parity data, using RAID data reconstruction techniques well-known in the art.

The write confirmation logic 124a, 124b includes logic (i.e., hardware and/or stored software capable of execution by any of the processors) operative to determine whether a particular write/store operation was successfully completed in the targeted memory device. In one example, the write confirmation logic 124a, 124b is operative to determine whether a given write/store operation was successfully completed by listening for an acknowledgement signal from the target memory device indicating that the write/store operation completed successfully. In this example, if the write confirmation logic 124a, 124b does not receive such an acknowledgement signal for a predetermined amount of time (i.e., the “time-out” duration), the write confirmation logic may notify the shared memory system administrator (e.g., a user operating a computing device containing the shared memory system 100) that the targeted memory device is defective. For example, the write confirmation logic 124a, 124b may generate an error message for display on a display device (e.g., a computer monitor operatively connected to a computing device containing the shared memory system 100) indicating that the targeted memory device is defective and needs to be replaced. Furthermore, in one example, upon a time out, the write confirmation logic 124a, 124b may initiate an error handling routine whereby the following actions may occur: (1) the write/store operation is re-tried or (2) the write confirmation logic 124a, 124b may issue an interrupt signal to error handling software configured to handle hardware failures, using techniques known in the art.

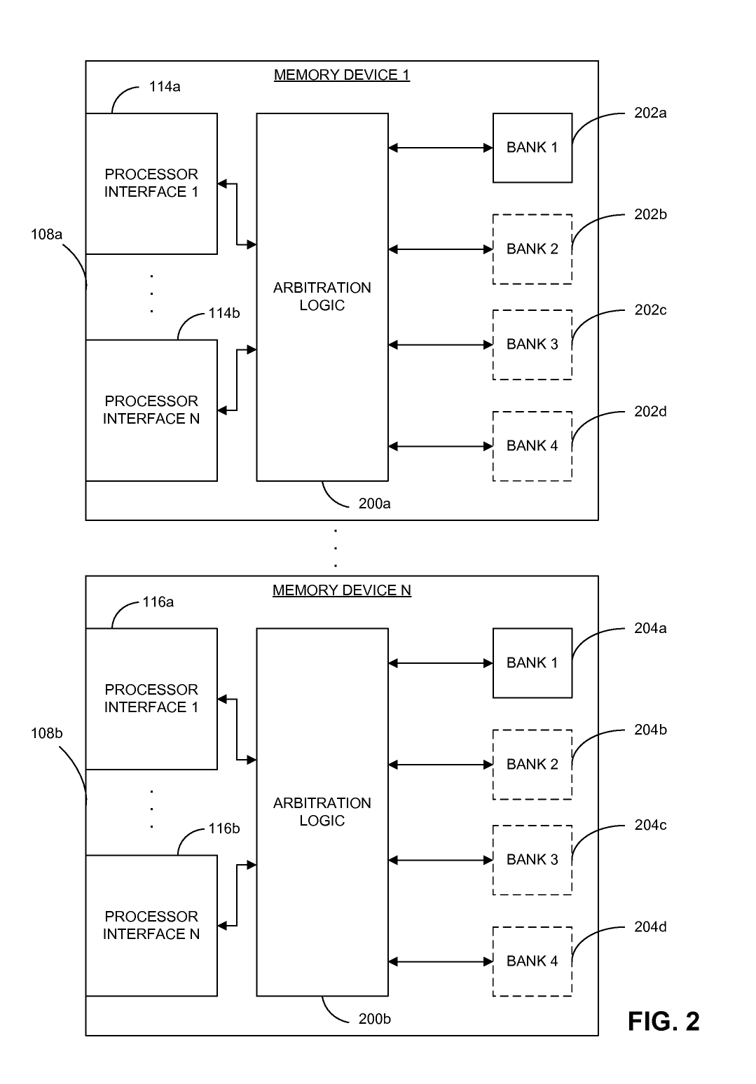

Referring now to FIG. 2, a block diagram generally depicting one detailed example of the memory device 108a, 108b is shown. Each memory device 108a, 108b includes a plurality of processor interfaces (e.g., processor interfaces 114a, 114b, 116a, 116b), where each processor interface is dedicated to a single processor. The processor interfaces are operatively connected to arbitration logic, such as arbitration logic 200a, 200b over a suitable communication channel, such as a bus. Each arbitration logic 200a, 200b is operatively connected to one or more memory banks, such as memory banks 202a-d, 204a-d over suitable communication channels, such as buses. Each memory bank (e.g., memory bank 202a) includes, for example, an addressable space of memory in a given memory device (e.g., memory device 108a) where data may be stored.

The arbitration logic (e.g., arbitration logic 200a, 200b) includes logic (i.e., hardware and/or stored software) operative to determine which individual processor to provide with exclusive access to the memory banks at a given time. For example, referring to memory device 108a, processor 1 106a may make a memory request of bank 1 202a over processor interface 1 114a. At substantially the same time, processor N 106b may also make a memory request of bank 1 202a over processor interface N 114b. In such a scenario, the arbitration logic 200a is configured to determine which processor (i.e., processor 1 106a or processor N 106b) to provide with exclusive access to memory bank 1 202a first in time. The arbitration logic 200a may employ any suitable arbitration technique known in the art to make this determination. For example, the arbitration logic 200a may determine that processor 1 106a gets exclusive access to memory bank 1 202a first, before providing processor N 106b with exclusive access to memory bank 1 202a.

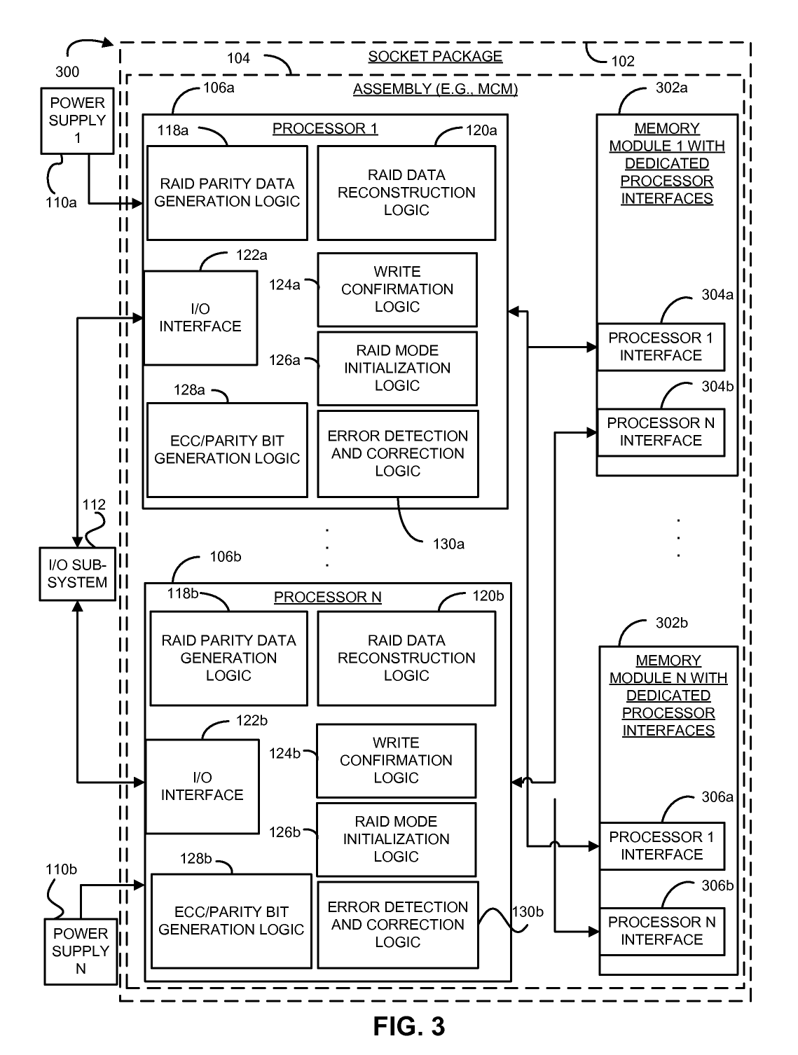

FIG. 3 illustrates one example of a shared memory system 300 for sharing memory (e.g., memory modules 302a, 302b) between a plurality of processors (e.g., processors 106a, 106b) in accordance with the present disclosure. The shared memory system 300 of FIG. 3 is similar to the shared memory system 100 of FIG. 1. However, the shared memory system 300 includes a plurality of memory modules (e.g., memory module 1 302a and memory module N 302b), rather than a plurality of memory devices (e.g., memory devices 108a, 108b). That is, whereas shared memory system 100 included a plurality of memory devices (e.g., memory chips), shared memory system 300 includes a plurality of memory modules, where each memory module includes one or more memory devices. Furthermore, while only two memory modules are illustrated, it is recognized that the system 300 may include as many memory modules and processors as desired.

As used with respect to the embodiments described herein, a memory module includes one or more memory devices (e.g., DRAM devices, SRAM devices, PVRM devices, Flash devices, etc.) capable of being accessed in parallel by a single processor. As will be discussed in greater detail below, the memory devices of a given memory module may be arranged horizontally, for example on a printed circuit board, or may be arranged in a vertical stack. Each memory module also includes a plurality of dedicated processor interfaces, such as processor interfaces 304a, 304b, 306a, 306b. Thus, each processor (e.g., processors 106a, 106b) in the shared memory system 300 may access any memory module via a dedicated processor interface (e.g., processor interfaces 304a, 304b, 306a, 306b). In this manner, should a given processor become defective, the other functioning processors may still access each memory module. In one example, the processors 106a, 106b and the memory modules 302a, 302b are arranged on the same assembly 104, such as a multi-chip module (MCM). In one example, the assembly 104 itself is arranged on a socket package 102. Additionally, each of the RAID techniques discussed above with respect to shared memory system 100 may equally be performed using shared memory system 300.

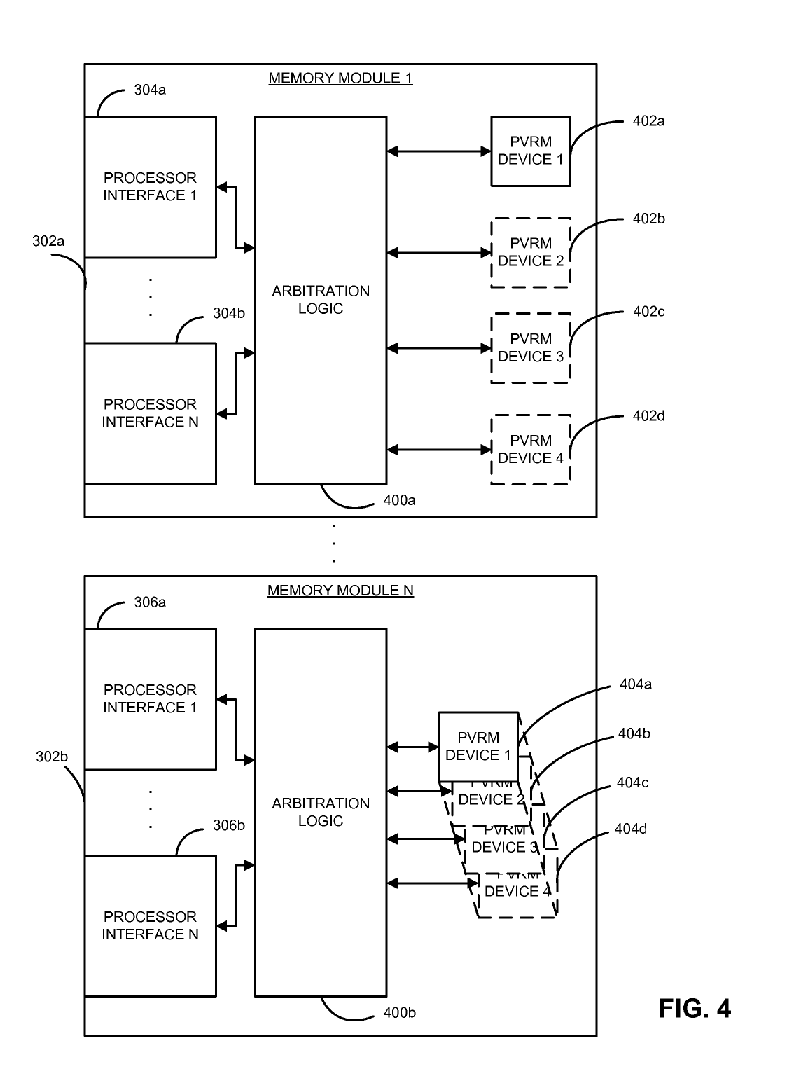

Referring now to FIG. 4, a block diagram generally depicting one detailed example of the memory modules 302a, 302b is shown. Each memory module 302a, 302b includes a plurality of processor interfaces (e.g., processor interfaces 304a, 304b, 306a, 306b), where each processor interface is dedicated to a single processor. The processor interfaces are connected to arbitration logic, such as arbitration logic 400a, 400b over a suitable communication channel, such as a bus. Each arbitration logic 200a, 200b is operatively connected to one or more memory devices, such as PVRM memory devices 402a-d, 404a-d, over a suitable communication channel, such as a bus. Each memory device (e.g., PVRM device 402a) includes, for example, a plurality of memory banks (not shown) comprising an addressable space of memory where data may be stored.

Memory module 1 302a illustrates one exemplary architecture wherein the memory devices (e.g., PVRM devices 1-4 402a-d) are arranged horizontally on memory module 1 302a. Conversely, memory module N 302b illustrates another exemplary architecture wherein the memory devices (e.g., PVRM devices 1-4 404a-d) are arranged in a stacked configuration on memory module N 302b. It is appreciated that any memory module in shared memory system 300 may include memory devices arranged in either a horizontal or stacked configuration.

Arbitration logic 400a, 400b is similar to arbitration logic 200a, 200b discussed above. Specifically, arbitration logic 400a, 400b includes logic (i.e., hardware and/or stored software) operative to determine which individual processor to provide with exclusive access to the memory devices of a given memory module at a given time. As noted above, the arbitration logic 400a, 400b is operative to make such a determination using arbitration techniques known in the art.

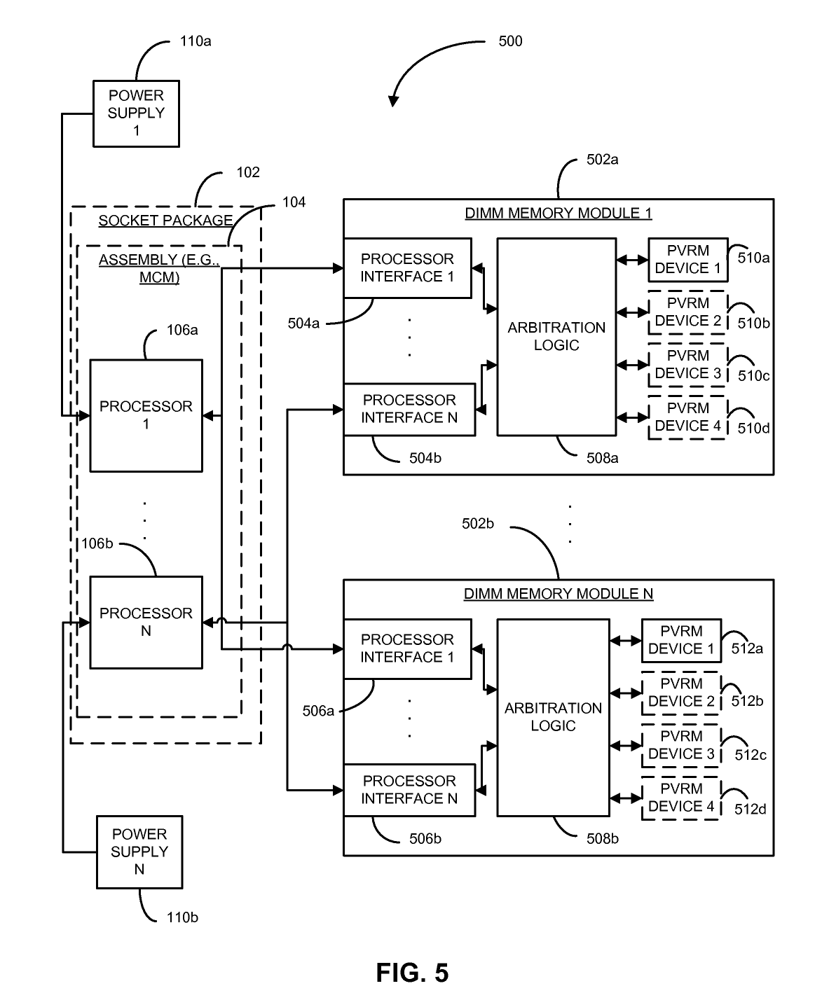

FIG. 5 illustrates another example of a shared memory system 500 for sharing memory (e.g., memory modules on DIMMs 502a, 502b) between a plurality of processors (e.g., processors 106a, 106b) in accordance with the present disclosure. The shared memory system 500 of FIG. 5 is similar to the shared memory system 300 of FIG. 3, however, in shared memory system 500, the memory modules 502a, 502b are arranged off-assembly from the processors 106a, 106b. In the example shown in FIG. 5, each memory module 502a, 502b is a dual in-line memory module (DIMM). As used with respect to the embodiments described herein, a DIMM refers to a collection of memory devices mounted on a shared surface, such as a printed circuit board. Each processor is operatively connected to each DIMM via a dedicated processor interface (e.g., processor interfaces 504a, 504b, 506a, 506b) over a suitable communication channel, such as a bus.

Arbitration logic 508a, 508b is substantially the same as arbitration logic 400a, 400b discussed above, and operates in substantially in the same manner. For example, arbitration logic 508a determines which processor to provide with exclusive access to the memory devices (e.g., PVRM devices 1-4 510a-510d) at a given time. As with the memory devices described above, each memory device (e.g., PVRM device 512a) includes, for example, a plurality of memory banks (not shown) comprising an addressable space of memory where data may be stored.

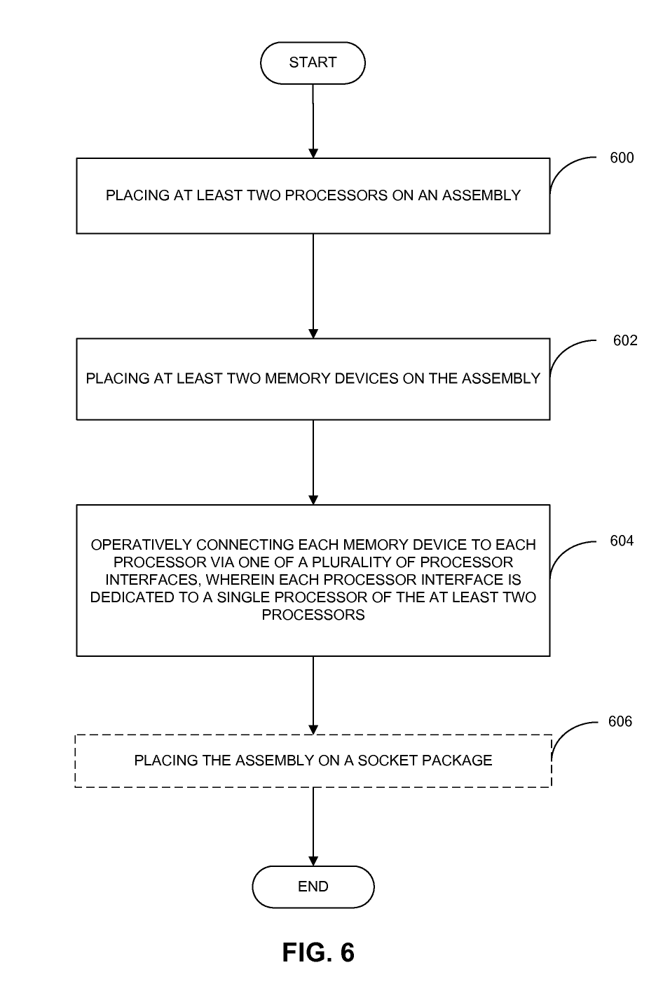

FIG. 6 is a flowchart illustrating one example of a method for making a shared memory system, such as, for example, shared memory system 100. At step 600, at least two processors are placed on an assembly. At step 602, at least two memory devices are placed on the assembly. At step 604, each memory device is operatively connected to each processor via one of a plurality of processor interfaces, wherein each processor interface is dedicated to a single processor of the at least two processors. In one example, the method may include optional step 606 wherein the assembly is placed on a socket package.

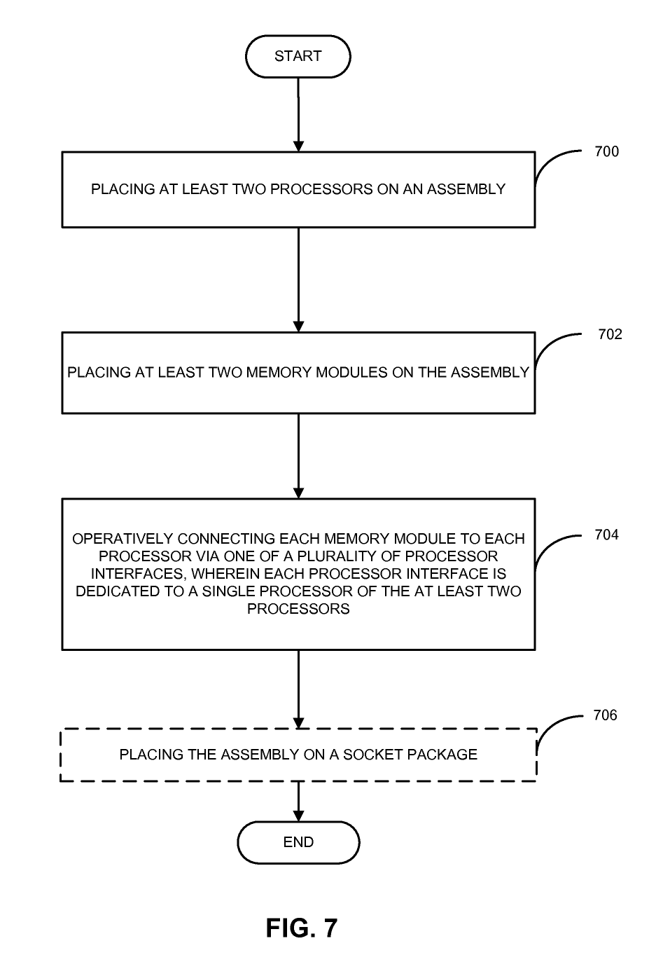

FIG. 7 is a flowchart illustrating another example of a method for making a shared memory system, such as, for example, shared memory system 300. At step 700, at least two processors are placed on an assembly. At step 702, at least two memory modules are placed on the assembly. At step 704, each memory module is operatively connected to each processor via one of a plurality of processor interfaces, wherein each processor interface is dedicated to a single processor of the at least two processors. In one example, the method may include optional step 706, wherein the assembly is placed on a socket package.

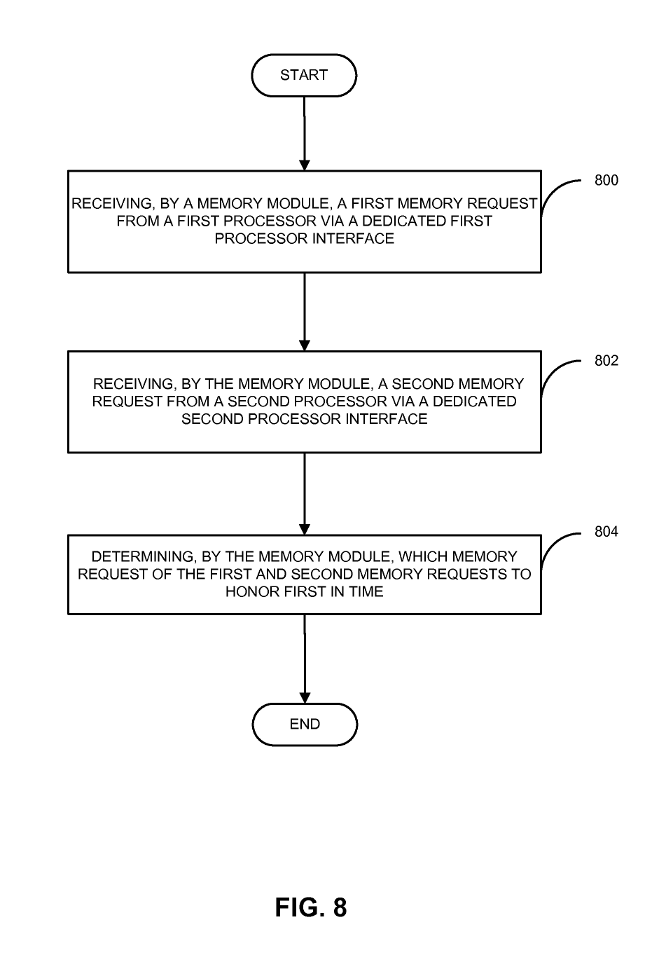

FIG. 8 is a flowchart illustrating one example of a method for sharing memory between at least two processors. The method of FIG. 8 may be carried out by, for example, the shared memory system 300 described above. Step 800 includes receiving, by a memory module, a first memory request from a first processor via a dedicated first processor interface. Step 802 includes receiving, by the memory module, a second memory request from a second processor via a dedicated second processor interface. Step 804 includes determining, by the memory module, which memory request of the first and second memory requests to honor first in time. For example, the arbitration logic of a given memory module may determine to honor (i.e., facilitate) the first memory request from the first processor before honoring (i.e., facilitating) the second memory request from the second processor.

In one example, each PVRM memory cell (e.g., 1 bit) may be a memristor of any suitable design. Since a memristor includes a memory region (e.g., a layer of TiO₂) between two metal contacts (e.g., platinum wires), memristors could be accessed in a cross point array style (i.e., crossed-wire pairs) with alternating current to non-destructively read out the resistance of each memory cell. A crossbar is an array of memory regions that can connect each wire in one set of parallel wires to every member of a second set of parallel wires that intersects the first set (usually the two sets of wires are perpendicular to each other, but this is not a necessary condition). The memristor disclosed herein may be fabricated using a wide range of material deposition and processing techniques. One example is disclosed in U.S. Patent Application Publication No. 2008/0090337 entitled “ELECTRICALLY ACTUATED SWITCH.”

In this example, first, a lower electrode is fabricated using conventional techniques such as photolithography or electron beam lithography, or by more advanced techniques, such as imprint lithography. This may be, for example, a bottom wire of a crossed-wire pair. The material of the lower electrode may be either metal or semiconductor material, preferably, platinum.

In this example, the next component of the memristor to be fabricated is the non-covalent interface layer, and may be omitted if greater mechanical strength is required, at the expense of slower switching at higher applied voltages. In this case, a layer of some inert material is deposited. This could be a molecular monolayer formed by a Langmuir-Blodgett (LB) process or it could be a self-assembled monolayer (SAM). In general, this interface layer may form only weak van der Waals-type bonds to the lower electrode and a primary layer of the memory region. Alternatively, this interface layer may be a thin layer of ice deposited onto a cooled substrate. The material to form the ice may be an inert gas such as argon, or it could be a species such as CO₂. In this case, the ice is a sacrificial layer that prevents strong chemical bonding between the lower electrode and the primary layer, and is lost from the system by heating the substrate later in the processing sequence to sublime the ice away. One skilled in this art can easily conceive of other ways to form weakly bonded interfaces between the lower electrode and the primary layer.

Next, the material for the primary layer is deposited. This can be done by a wide variety of conventional physical and chemical techniques, including evaporation from a Knudsen cell, electron beam evaporation from a crucible, sputtering from a target, or various forms of chemical vapor or beam growth from reactive precursors. The film may be in the range from 1 to 30 nanometers (nm) thick, and it may be grown to be free of dopants. Depending on the thickness of the primary layer, it may be nanocrystalline, nanoporous or amorphous in order to increase the speed with which ions can drift in the material to achieve doping by ion injection or undoping by ion ejection from the primary layer. Appropriate growth conditions, such as deposition speed and substrate temperature, may be chosen to achieve the chemical composition and local atomic structure desired for this initially insulating or low conductivity primary layer.

The next layer is a dopant source layer, or a secondary layer, for the primary layer, which may also be deposited by any of the techniques mentioned above. This material is chosen to provide the appropriate doping species for the primary layer. This secondary layer is chosen to be chemically compatible with the primary layer, e.g., the two materials should not react chemically and irreversibly with each other to form a third material. One example of a pair of materials that can be used as the primary and secondary layers is TiO₂ and TiO₂₋ₓ, respectively. TiO₂ is a semiconductor with an approximately 3.2 eV bandgap. It is also a weak ionic conductor. A thin film of TiO₂ creates the tunnel barrier, and the TiO₂₋ₓ forms an ideal source of oxygen vacancies to dope the TiO₂ and make it conductive.

Finally, the upper electrode is fabricated on top of the secondary layer in a manner similar to which the lower electrode was created. This may be, for example, a top wire of a crossed-wire pair. The material of the lower electrode may be either metal or semiconductor material, preferably, platinum. If the memory cell is in a cross point array style, an etching process may be necessary to remove the deposited memory region material that is not under the top wires in order to isolate the memory cell. It is understood, however, that any other suitable material deposition and processing techniques may be used to fabricate memristors for the passive variable-resistive memory.

Among other advantages, the disclosed systems and methods provide a shared memory system capable of implementing RAID without the use of hard disks. Using non-hard disk types of storage (e.g., PVRM) reduces memory access time, minimizes the size of the memory system, and, in one embodiment, provides persistent (i.e., non-volatile) storage. Additionally, the disclosed systems and methods provide memory devices and memory modules having dedicated processor interfaces for a plurality of processors. In this manner, when any individual processor becomes defective, other functional processors may still access data stored in a given memory device/memory module. Other advantages will be recognized by those of ordinary skill in the art.

Also, integrated circuit design systems (e.g., workstations) are known that create integrated circuits based on executable instructions stored on a computer readable memory such as but not limited to CD-ROM, RAM, other forms of ROM, hard drives, distributed memory, etc. The instructions may be represented by any suitable language such as but not limited to hardware descriptor language or any other suitable language. As such, the systems described herein may also be produced as integrated circuits by such systems. For example, an integrated circuit may be created using instructions stored on a computer readable medium that when executed cause the integrated circuit design system to create an integrated circuit that is operative to receive, by a memory module, a first memory request from a first processor via a dedicated first processor interface; receive, by the memory module, a second memory request from a second processor via a dedicated second processor interface; and determine, by the memory module, which memory request of the first and second memory requests to honor first in time. Integrated circuits having logic that performs other operations described herein may also be suitably produced.

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. A shared memory system comprising:
at least two processors;
at least two memory devices, each memory device operatively connected to each processor via one of a plurality of processor interfaces, wherein each processor interface is dedicated to a single processor of the at least two processors; and
wherein any individual processor of the at least two processors is operative to access data stored in any individual memory device of the at least two memory devices via the processor interface dedicated to a respective individual processor.

2. The shared memory system of claim 1, wherein the at least two memory devices comprise passive variable resistive memory (PVRM).

3. The shared memory system of claim 2, wherein the PVRM comprises at least one of phase-change memory, spin-torque transfer magnetoresistive memory, and memristor memory.

4. The shared memory system of claim 1, further comprising:
an assembly, wherein the assembly comprises the at least two processors.

5. The shared memory system of claim 4, wherein the assembly further comprises the at least two memory devices, and wherein each memory device is operatively connected to each processor via a respective dedicated bus.

6. The shared memory system of claim 4, wherein each memory device is external to the assembly and operatively connected to each processor via a respective dedicated bus.

7. The shared memory system of claim 1, wherein each memory device comprises arbitration logic and at least one memory bank, the arbitration logic operatively connected to each at least one memory bank and each processor interface, wherein the arbitration logic is operative to determine which individual processor of the at least two processors to provide with exclusive access to any at least one memory bank at a given time.

8. The shared memory system of claim 1, wherein at least one of the at least two processors further comprises RAID mode initialization logic operative to configure the at least two memory devices as a RAID memory system.

9. The shared memory system of claim 1, wherein at least one of the at least two memory devices comprises a parity memory device operative to store parity data used to reconstruct data requested from at least one memory device other than the at least one parity memory device.

10. The shared memory system of claim 9, wherein at least one of the at least two processors further comprises:
RAID parity data generation logic operative to generate the parity data for storage in the at least one parity memory device; and
RAID data reconstruction logic operative to reconstruct requested data that was not received from a defective memory device based on the parity data.

11. A shared memory system comprising:
at least two processors;
at least two memory modules, each memory module operatively connected to each processor via one of a plurality of processor interfaces, wherein each processor interface is dedicated to a single processor of the at least two processors; and
wherein any individual processor of the at least two processors is operative to access data stored in any individual memory module of the at least two memory modules via the processor interface dedicated to a respective individual processor.

12. The shared memory system of claim 11, wherein each processor is operatively connected to a dedicated power supply such that a power failure associated with any individual processor will not prohibit another processor from accessing data stored in any of the memory modules.

13. The shared memory system of claim 11, wherein the at least two memory modules comprise passive variable resistive memory (PVRM).

14. The shared memory system of claim 13, wherein the PVRM comprises at least one of phase-change memory, spin-torque transfer magnetoresistive memory, and memristor memory.

15. The shared memory system of claim 11, further comprising:
an assembly, wherein the assembly comprises the at least two processors.

16. The shared memory system of claim 15, wherein the assembly further comprises the at least two memory modules, and wherein each memory module is operatively connected to each processor via a respective dedicated bus.

17. The shared memory system of claim 15, wherein each memory module is external to the assembly and operatively connected to each processor via a respective dedicated bus.

18. The shared memory system of claim 16, wherein at least one memory module of the at least two memory modules comprises a plurality of memory devices arranged in a stacked configuration.

19. The shared memory system of claim 11, wherein each memory module comprises arbitration logic and at least one memory device, the arbitration logic operatively connected to each at least one memory device and each processor interface, wherein the arbitration logic is operative to determine which individual processor of the at least two processors to provide with exclusive access to any at least one memory device at a given time.

20. The shared memory system of claim 11, wherein at least one of the at least two processors further comprises RAID mode initialization logic operative to configure the at least two memory modules as a RAID memory system.

21. The shared memory system of claim 11, wherein at least one of the at least two memory modules comprises a parity memory module operative to store parity data used to reconstruct data requested from at least one memory device other than the at least one parity memory device.

22. The shared memory system of claim 21, wherein at least one of the at least two processors further comprises:
RAID parity data generation logic operative to generate the parity data for storage in the at least one parity memory module; and
RAID data reconstruction logic operative to reconstruct requested data that was not received from a defective memory module based on the parity data.

23. A method for making a shared memory system, the method comprising:
placing at least two processors on an assembly;
placing at least two memory devices on the assembly; and
operatively connecting each memory device to each processor via one of a plurality of processor interfaces, wherein each processor interface is dedicated to a single processor of the at least two processors.

24. The method of claim 23, further comprising:
placing the assembly on a socket package.

25. A method for making a shared memory system, the method comprising:
placing at least two processors on an assembly;
placing at least two memory modules on the assembly; and
operatively connecting each memory module to each processor via one of a plurality of processor interfaces, wherein each processor interface is dedicated to a single processor of the at least two processors.

26. The method of claim 25, further comprising:
placing the assembly on a socket package.

27. A method for sharing memory between at least two processors, the method comprising:
receiving, by a memory module, a first memory request from a first processor via a dedicated first processor interface;
receiving, by the memory module, a second memory request from a second processor via a dedicated second processor interface; and
determining, by the memory module, which memory request of the first and second memory requests to honor first in time.
